(19) United States
(12) Patent Application Publication
(10) Pub. No.: US 2026/0307622 A1
(43) Pub. Date: Oct. 8, 2026

(54) HEATER CONTROL DEVICE

(71) Applicant: TOYOTA JIDOSHA KABUSHIKI KAISHA, Toyota-shi (JP)

(72) Inventors: Takayuki Mashimo, Toyota-shi (JP); Iwao Izumikawa, Toyota-shi (JP)

(73) Assignee: TOYOTA JIDOSHA KABUSHIKI KAISHA, Toyota-shi (JP)

(21) Appl. No.: 19/465,005

(22) Filed: Jan. 30, 2026

(30) Foreign Application Priority Data
Apr. 2, 2025 (JP) 2025-061468

(51) Int. Cl. B60S 1/38

(52) U.S. Cl. CPC B60S 1/3805

(57) ABSTRACT

A heater control device that performs powering up control of a heater provided to heat an outer face of a vehicle, in which when an outside air temperature around the vehicle is below a reference temperature that is higher than 0 °C, and also an operation signal for a windshield wiper of the vehicle is received continuously for a predetermined reference time that is set in advance, or longer, the heater is powered up.

### CROSS-REFERENCE TO RELATED APPLICATION

This application claims priority to Japanese Patent Application No. 2025-061468 filed on Apr. 2, 2025. The disclosure of the above-identified application, including the specification, drawings, and claims, is incorporated by reference herein in its entirety.

### BACKGROUND

### 1. Technical Field

The present disclosure relates to a heater control device.

### 2. Description of Related Art

There is known a heater system that is installed on a rear face of a vehicle equipped with lights and sensors, and in order to suppress snow from accumulating on the rear face of the vehicle during snowfall, includes a heater, a temperature sensor that measures outside air temperature, and a control unit that performs powering up control of the heater based on measurement values of the temperature sensor (Japanese Unexamined Patent Application Publication No. 2020-030908 (JP 2020-030908 A)). In the heater system described in JP 2020-030908 A, the control unit powers up the heater when a measurement value of the temperature sensor is −15° C or higher and below 5° C, and powers down the heater when the measurement value of the temperature sensor is below −15° C or 5° C or higher.

### SUMMARY

In the heater system described in JP 2020-030908 A, when the outside air temperature is −15° C or higher and below 5° C, the heater is uniformly powered up. However, in such cases, dry snow may be falling, and powering up the heater when dry snow is falling may actually promote accumulation of snow in a region where the heater is installed.

In light of the foregoing problem, an object of the present disclosure is to suppress snow from accumulating in a region where a heater is provided.

An overview of the present disclosure is as follows.

(1) A heater control device that performs powering up control of a heater provided to heat an outer face of a vehicle, in which

when an outside air temperature around the vehicle is below a reference temperature that is higher than 0° C, and also an operation signal for a windshield wiper of the vehicle is received continuously for a predetermined reference time that is set in advance, or longer, the heater is powered up.

(2) The heater control device according to (1) above, in which, when the outside air temperature is within a predetermined temperature range including the reference temperature and is the reference temperature or higher, and the operation signal for the windshield wiper of the vehicle is received, the heater is powered up.

(3) The heater control device according to (2) above, in which the temperature range is -5° C to 5° C.

(4) The heater control device according to any one of (1) to (3) above, in which the heater heats a sensor provided on the outer face of the vehicle or a transparent cover that covers the sensor provided to the vehicle.

(5) A heater control device according to any one of (1) to (4) above, in which, when the outside air temperature is the reference temperature or higher, and also a stop signal for the windshield wiper is received while the heater is powered up, the heater is powered down.

According to the present disclosure, snow is suppressed from accumulating on the region where the heater is provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a front view of a vehicle equipped with a heater control device according to an embodiment;

FIG. 2 is a cross-sectional view illustrating a configuration in a vicinity of a front bumper, taken along line II-II in FIG. 1;

FIG. 3 is a schematic block diagram illustrating a configuration of a heater system;

FIG. 4 is a flowchart showing a flow of heater-on processing for starting to power up a heater; and

FIG. 5 is a flowchart showing a flow of heater-off processing for powering down the heater.

### DETAILED DESCRIPTION OF EMBODIMENTS

Hereinafter, an embodiment will be described in detail with reference to the drawings. Note that in the following description, similar components are denoted by the same reference numbers.

### Configuration of Vehicle

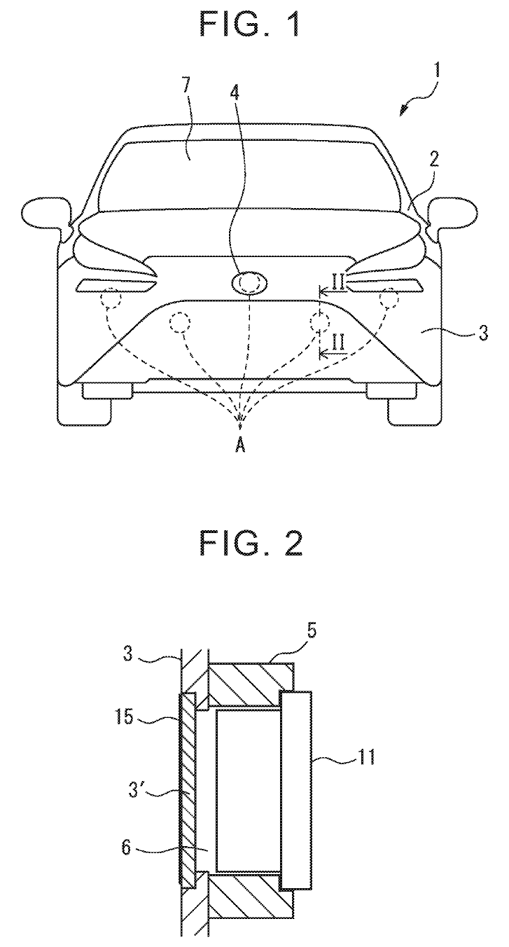

First, with reference to FIG. 1, a vehicle 1 equipped with a heater control device according to an embodiment will be briefly described. FIG. 1 is a front view of the vehicle 1 equipped with the heater control device according to the embodiment.

In the present embodiment, the vehicle 1 is a four-wheeled automobile and has a box-like outer shape. As illustrated in FIG. 1, the vehicle 1 includes a body panel 2 and a front bumper 3 as components that make up exterior panels thereof. Also, an emblem 4 of the vehicle 1 is disposed at the middle of the front bumper 3. Note that the vehicle 1 may be a vehicle other than a four-wheel vehicle, such as a three-wheel vehicle or the like. In the present embodiment, the front bumper 3 and the emblem 4 are made of resin, but may be made of other materials.

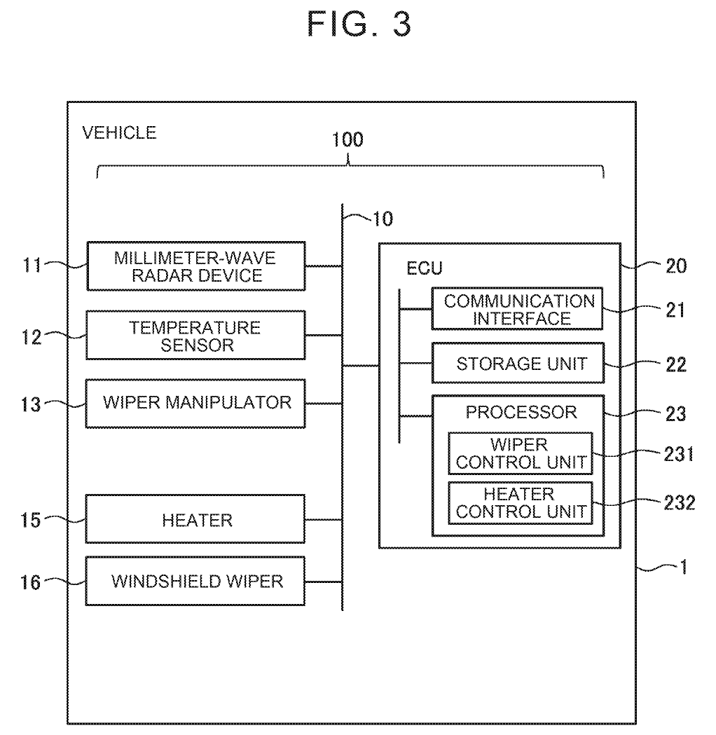

Also, in the present embodiment, a millimeter wave radar device 11 (see FIGS. 2 and 3) is disposed on an inner side of the front bumper 3 and the emblem 4. The millimeter wave radar device 11 that is disposed on the inner side of the front bumper 3 and the emblem 4 detects objects that are present forward of the vehicle 1. The millimeter wave radar device 11 may also be disposed on a rearward exterior panel of the vehicle, such as a rear bumper or the like. In addition, the millimeter wave radar device may be attached to an exterior panel member other than the front bumper 3, the emblem 4, and the rear bumper.

In the present embodiment, the millimeter wave radar device 11 is provided on the inner side of the front bumper 3 and the emblem 4 at positions indicated by dashed lines A in FIG. 1. In the present embodiment, a plurality of the millimeter wave radar devices 11 (five in the example illustrated in FIG. 1) is provided on the front bumper 3, and these millimeter wave radars 11 are disposed spaced apart from each other in a vehicle width direction. Millimeter wave radar devices 11 are disposed in the rear bumper in the same way.

FIG. 2 is a cross-sectional view illustrating a configuration in a vicinity of the front bumper 3, taken along line II-II in FIG. 1. As illustrated in FIG. 2, the millimeter wave radar device 11 is disposed on the inner side of the front bumper 3. In particular, in the present embodiment, the millimeter-wave radar device 11 is attached to the inner side of the front bumper 3 by an attaching fixture 5 for attaching the millimeter-wave radar device 11 to the front bumper 3.

The front bumper 3 also includes a through hole 6 formed passing through the front bumper 3 at a position at which the millimeter wave radar device 11 is attached. The through-hole 6 is disposed in a direction in which detection is performed by the millimeter wave radar device 11. Accordingly, the millimeter wave radar device 11 detects distances to surrounding objects through the through hole 6.

Further, a transparent cover 3′ is provided on this through hole 6 so as to close off the through hole 6. The transparent cover 3' is made of a resin with high radio wave permeability and is formed thinner than the front bumper 3. The transparent cover 3' may be made of the same material as the front bumper 3, or may be made of a different material therefrom. Also, when made of the same material as the front bumper 3, the transparent cover 3′ may be formed integrally with the front bumper 3.

Also, in the present embodiment, a heater 15 is disposed on an outer face of the transparent cover 3′ that is disposed so as to cover the millimeter wave radar device 11 in a detecting direction of the millimeter wave radar device 11. In the present embodiment, the heater 15 is a heating wire provided on the outer face of the transparent cover 3'. The heater 15 functions to melt snow, in a case in which snow is accumulating on the outer face of the transparent cover 3'. Note that the heater 15 may be configured in any way as long as it is capable of melting snow accumulating on members disposed in the detecting direction of the millimeter wave radar device 11 (transparent cover 3' in example illustrated in FIG. 2). Accordingly, the heater 15 may be disposed on the inner side of the transparent cover 3' in a case in which the transparent cover 3' has high thermal conductivity, for example. The heater 15 may also be equipment that heats using a different principle from that of the heating wire, such as equipment that performs heating using radiant heat, or the like.

The millimeter wave radar device 11 is also disposed inside the emblem 4 in the same manner as on the inner side of the front bumper 3. Accordingly, the millimeter wave radar device 11 is disposed on the inner side of the through hole in which the emblem 4 is provided, and also, the emblem 4 is made of a material with high radio wave permeability. In addition, the heater 15 is disposed on an outer face of the emblem 4.

Note that in the example illustrated in FIG. 2, the transparent cover 3′ is provided in the detecting direction of the millimeter wave radar device 11. However, the transparent cover 3' does not have to be provided. In this case, the millimeter wave radar device 11 is disposed such that a detecting face thereof is exposed to the outside, similar to an outer face of the front bumper 3. Also, in this case, the heater 15 is disposed so as to directly heat the detecting face of the millimeter wave radar device 11. Accordingly, when snow accumulates on the detecting face of the millimeter wave radar device 11, the heater 15 can melt the snow accumulating on the detecting face. In either case, the heater 15 is provided to heat an outer face of the vehicle 1.

Next, a configuration of a heater system 100 including the heater control device according to an embodiment will be described with reference to FIG. 3. The heater system 100 performs powering up control of the heater 15 provided on the outer face of the vehicle 1. FIG. 3 is a schematic block diagram illustrating the configuration of the heater system 100.

As illustrated in FIG. 3, in the present embodiment, the heater system 100 includes the millimeter wave radar device 11, a temperature sensor 12, a wiper manipulator 13, the heater 15, a windshield wiper 16, and an electronic control unit (hereinafter referred to as “ECU”) 20. The millimeter wave radar device 11, the temperature sensor 12, the wiper manipulator 13, the heater 15, the windshield wiper 16, and the ECU 20 are communicably connected to one another via, for example, an in-vehicle network 10. The in-vehicle network 10 is a network that conforms to standards such as controller area network (CAN) bus or the like, for example. Alternatively, these devices may be directly connected to each other via signal lines, at least in part, without going through the in-vehicle network 10.

The millimeter wave radar device 11 is an example of a ranging sensor that detects distances to objects situated around the vehicle 1. The millimeter wave radar device 11 outputs measurement data of distances to objects in the periphery of the vehicle 1 (particularly forward of vehicle 1) to the ECU 20 via the in-vehicle network 10, at predetermined cycles. Note that instead of the millimeter wave radar device 11, other ranging sensors such as, for example, a LiDAR device, a sonar device, or the like, may be used.

The temperature sensor 12 is a sensor that detects the outside air temperature around the vehicle 1. The temperature sensor 12 outputs measurement data of the outside air temperature around the vehicle 1 to the ECU 20 via the in-vehicle network 10 at predetermined cycles.

The wiper manipulator 13 is an operating tool that is operated by an occupant of the vehicle 1 to control the windshield wiper 16. Operation positions of the wiper manipulator 13 can be switched among, for example, a wiper stop instruction position at which the windshield wiper actions are stopped, a wiper intermittent operation instruction position at which the windshield wiper acts intermittently, and a wiper continuous operation instruction position at which the windshield wiper acts continuously. The wiper manipulator 13 outputs signals to the ECU 20 in accordance with the operation position.

The heater 15 is provided at the position where the millimeter wave radar device 11 is provided, so as to heat the outer face of the vehicle 1. In particular, in the present embodiment, the heater 15 is disposed so as to heat the transparent cover 3′ (including emblem 4 ) provided at a position corresponding to the millimeter wave radar device 11. Also, as described above, when the millimeter wave radar device 11 is provided on the outer face of the vehicle 1, the heater 15 is disposed so as to heat the millimeter wave radar device 11 provided on the outer face of the vehicle 1. The heater 15 is powered up based on a power-up signal from the ECU 20, so as to heat the outer face of the vehicle 1.

The windshield wiper 16 is a device that wipes the surface of a windshield 7 (see FIG. 1) of the vehicle 1. When the windshield wiper 16 is operated, raindrops, snow, and so forth, are wiped off the windshield 7. The windshield wiper 16 operates in response to an operation signal from the ECU 20 and stops in response to a stop signal from the ECU 20.

### Overview of ECU

The ECU 20 functions as a heater control device that performs powering up control of the heater in the vehicle 1. In the example illustrated in FIG. 3, the heater system 100 includes one ECU 20, but may include a plurality of ECUs 20, each having a different function. The ECU 20 has a communication interface 21, a storage unit 22, and a processor 23. Note that the communication interface 21, the storage unit 22, and the processor 23 may be separate circuits, or may be configured as a single integrated circuit.

The communication interface 21 is a circuit for connecting the ECU 20 to the in-vehicle network 10. The communication interface 21 transmits signals received from the millimeter wave radar device 11, the temperature sensor 12, and the wiper manipulator 13, to the processor 23. The communication interface 21 also transmits signals output from the processor 23 to the heater 15.

The storage unit 22 stores data. The storage unit 22 has, for example, at least one of volatile semiconductor memory, non-volatile semiconductor memory, a hard disk drive (HDD), and a solid state drive (SSD). The storage unit 22 stores programs that are executed by the processor 23. The storage unit 22 also stores data transmitted from various types of sensors.

The processor 23 has one or a plurality of central processing units (CPUs) and peripheral circuits thereof. The processor 23 may further have other computing circuits such as a logical operation unit or a numerical operation unit. The processor 23 executes the computer programs stored in the storage unit 22.

As illustrated in FIG. 3, the processor 23 includes a wiper control unit 231 and a heater control unit 232. These units included in the processor 23 are, for example, functional modules realized by a computer program running on the processor 23. Alternatively, each part of the processor 23 may be implemented in the ECU 20 as an independent integrated circuit, microprocessor, or firmware.

The wiper control unit 231 transmits, to the windshield wiper 16, control signals for controlling the windshield wiper 16 based on signals from the wiper manipulator 13, and output of a rainfall sensor (omitted from illustration) that detects rainfall. When the operation position of the wiper manipulator 13 is the wiper stop instruction position, the wiper control unit 231 outputs a stop signal to the windshield wiper 16. Also, when the operation position of the wiper manipulator 13 is at the wiper intermittent operation instruction position, the wiper control unit 231 outputs an operation signal to the wiper 16 when raindrops or snow are detected by the rainfall sensor, and outputs a stop signal to the windshield wiper 16 when raindrops or snow are not detected by the rainfall sensor. Also, the wiper control unit 231 outputs an operation signal to the windshield wiper 16 when the operation position of the wiper manipulator 13 is at the wiper continuous operation instruction position. Note that the above-described form of control of the windshield wiper 16 by the wiper control unit 231 is one example, and the wiper control unit 231 may control the windshield wiper 16 in a form of control different from the above-described form of control.

The heater control unit 232 controls powering up of the heater 15 based on the measurement data of the millimeter wave radar device 11, the measurement data of the temperature sensor 12, and control signals to the windshield wiper 16 from the wiper control unit 231.

In the present embodiment, the heater 15 is used to melt snow that has accumulated on the outer faces of the front bumper 3 and the emblem 4. When operation signals are being output to the windshield wiper 16, it is generally conceivable that snow or rain is falling. Accordingly, the heater control unit 232 basically can power up the heater 15 to heat the heater 15 when an operation signal for the windshield wiper 16 is received and the outside air temperature is within a predetermined reference temperature range. Also, when the outside air temperature is outside of the reference temperature range or when no operation signal to the windshield wiper 16 is being output, the heater control unit 232 does not power up the heater 15 and does not perform heating by the heater 15. When the outside air temperature is higher than the reference temperature range, rain falls instead of snow, and accordingly no snow will accumulate on the outer faces of the front bumper 3 and the emblem 4. Also, when the outside air temperature is below the reference temperature range, dry snow falls, but dry snow generally does not accumulate on the outer faces of the front bumper 3 and the emblem 4. In this way, when the outside air temperature is outside the reference temperature range, heating by the heater 15 is not performed, thereby suppressing the heater 15 from unnecessarily consuming power.

Here, the reference temperature range is, for example, −5° C to 5° C. Accordingly, when the outside air temperature detected by the temperature sensor 12 is below −5° C or higher than 5° C, the heater 15 is not powered up. However, the reference temperature range may be a range below other temperatures, such as 3° C or below, 7° C or below, or the like, instead of 5° C or below, as long as it is a temperature at which rain is more likely to fall than snow. Also, the reference temperature range may be a range of −3° C or higher, −10° C or higher, or −15° C or higher, rather than −5° C or higher, as long as it is a temperature at which wet snow may fall.

In addition, wet snow tends to accumulate on the outer faces of the front bumper 3 and the emblem 4. Accordingly, when estimation is made that wet snow is falling, the heater control unit 232 powers up the heater 15 to cause the heater 15 to perform heating. In particular, wet snow is likely to fall when the outside air temperature is at a relatively high temperature within a predetermined reference temperature range. Accordingly, in the present embodiment, the heater control unit 232 powers up the heater 15 when the outside air temperature detected by the temperature sensor 12 that has received the operation signal for the windshield wiper 16 is equal to or higher than the predetermined reference temperature. Here, the reference temperature is, for example, 1° C. However, the reference temperature may be a temperature other than 1° C, such as, for example, 0.5° C, 2° C, or the like, which are temperatures other than 1° C, as long as it is a temperature at which wet snow is more likely to fall than dry snow. Nonetheless, the reference temperature is set to a temperature higher than 0° C.

On the other hand, when the outside air temperature is below the reference temperature within the reference temperature range, there is a possibility that either of both dry snow and wet snow may fall. Accordingly, in the present embodiment, when the outside air temperature is below the reference temperature, within the reference temperature range (e.g., when outside air temperature is −5° C to 1° C), the powering up of the heater 15 is controlled based on the outside air temperature detected by the temperature sensor 12, as well as signals output from the wiper control unit 231.

Specifically, in the present embodiment, when the outside air temperature is below the reference temperature, within the reference temperature range, the heater control unit 232 powers up the heater 15 when continuously receiving operation signals from the wiper control unit 231 over a predetermined reference time that is set in advance, or longer. On the other hand, when the outside air temperature is below the reference temperature within the reference temperature range, the heater control unit 232 does not power up the heater 15 when only receiving operation signals from the wiper control unit 231 over an amount of time that is less than the reference time. Here, the reference time is three seconds, for example. However, the reference time may be an amount of time other than three seconds, such as for example, one second or five seconds, as long this corresponds to a wiper operation duration when an occupant operates the windshield wiper 16 for one wipe (or a few wipes) when dry snow is falling.

Now, when dry snow is falling, snow generally does not accumulate on the windshield 7, and accordingly there is no need to operate the windshield wiper 16. Also, even when the windshield wiper is operated, once the wiping operation is performed once or twice, snow does not accumulate on the windshield 7 thereafter, and accordingly the wiping operation is not performed thereafter. Accordingly, when dry snow is falling, the windshield wiper 16 is operated just for one wipe (or a few wipes) for a very short amount of time. On the other hand, when wet snow is falling, snow accumulates on the windshield 7, thus causing the windshield wiper 16 to be operated continuously. From the above, it is conceivable that when operation signals for the windshield wiper 16 are being output over a period of time equal to or longer than the reference time, wet snow is falling and snow is accumulating on the outer faces of the front bumper 3 and the emblem 4. On the other hand, when the operation signal for the windshield wiper 16 has been only output for less than the reference time, it is conceivable that dry snow is falling and no snow will accumulate on the outer faces of the front bumper 3 and the emblem 4.

In the present embodiment, when operation signals for the windshield wiper 16 are received continuously over the reference time or longer, i.e., when it is conceivable that wet snow is falling, the heater 15 is powered up. On the other hand, when operation signals for the windshield wiper 16 are only received over less than the reference time, i.e., when it is conceivable that dry snow is falling, the heater 15 is powered down. This means that the heater 15 is powered up only when wet snow is falling and it is necessary to melt the snow, which can suppress snow from accumulating on the transparent cover 3' and the outer face of the emblem 4, which are the regions in which the heater 15 is installed, and can also suppress power consumption from unnecessary powering up. In particular, when dry snow is falling, and the heater 15 is powered up, the dry snow that would not normally accumulate on the outer faces of the transparent cover 3' and the emblem 4 melts on the transparent cover 3' and the emblem 4, inducing snow to accumulate on the transparent cover 3' and the emblem 4, but the powering up of the heater 15 is suppressed when dry snow is falling, and accordingly such induction of snow accumulation is suppressed.

Also, in the present embodiment, when the outside air temperature is the reference temperature or higher, and a stop signal to stop the windshield wiper 16 is received while the heater 15 is being powered up, the heater control unit 232 powers down the heater 15. Now, when the outside air temperature is the reference temperature or higher, any snowfall will be wet snow. However, in this case, the fact that the windshield wiper 16 is stopped means that it is not snowing. Thus, when the outside air temperature is the reference temperature or higher, and a stop signal to stop the windshield wiper 16 is received, it is conceivable that there is no snow falling, and accordingly the heater 15 is powered down. This suppresses the heater 15 from being unnecessarily powered up, thereby suppressing increase in power consumption.

### Flow of Control

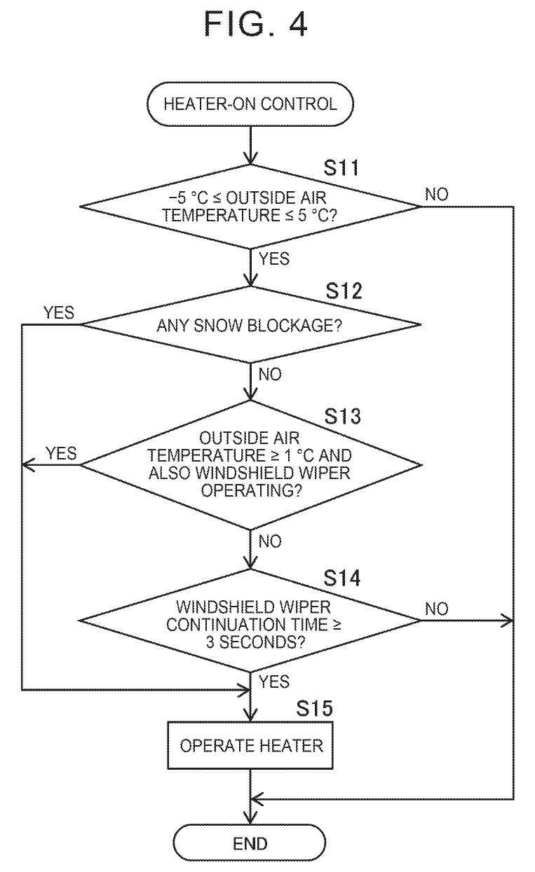

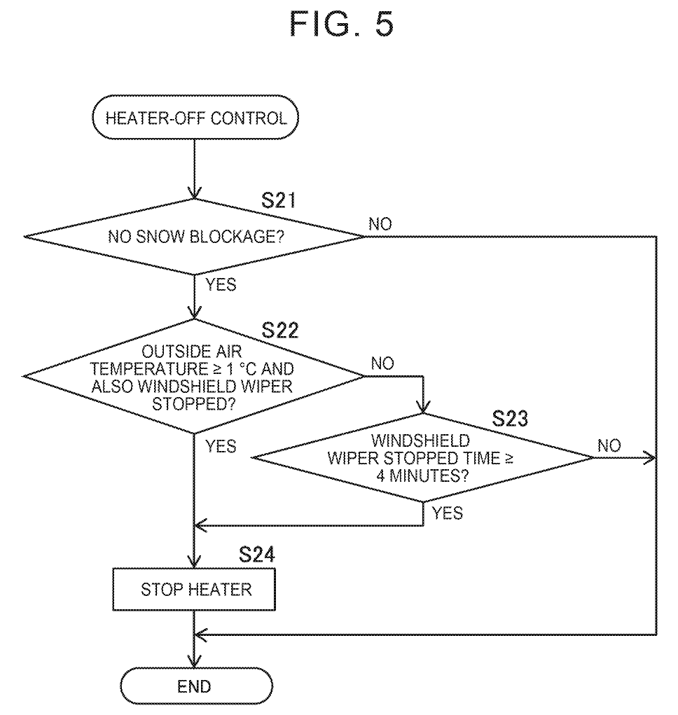

Next, the flow of control of the heater 15 by the heater control device will be described with reference to FIGS. 4 and 5. FIG. 4 is a flowchart showing the flow of heater-on processing for starting to power up the heater 15. The heater-on processing shown in FIG. 4 is executed by the processor 23 at regular time intervals when the heater 15 is powered down.

When the heater-on process is started, the heater control unit 232 first determines whether the outside air temperature detected by the temperature sensor 12 is −5˚ C or higher and 5˚ C or lower, i.e., within the reference range (step S11). When determination is made in step S11 that the outside air temperature detected by the temperature sensor 12 is below -5° C or higher than 5° C, the heater-on processing ends. Accordingly, powering up of the heater 15 is not started.

On the other hand, when determination is made in step S11 that the outside air temperature detected by the temperature sensor 12 is −5° C or higher and 5° C or below, the heater control unit 232 determines whether there is snow blockage forward (i.e., on transparent cover 3' and emblem 4) of the millimeter wave radar device 11 (step S12). The determination of whether there is snow blockage is made based on, for example, whether there is an abnormality in the output of the millimeter wave radar device 11. When there is snow blockage, millimeter waves emitted from the millimeter wave radar device 11 are scattered, thus causing the millimeter wave radar device 11 to perform abnormal output. When determination is made in step S12 that there is snow blockage, the heater control unit 232 powers up the heater 15 (step S15).

On the other hand, when determination is made in step S12 that there is no snow blockage, the heater control unit 232 determines whether the outside air temperature detected by the temperature sensor 12 is 1° C or higher (i.e., reference temperature or higher) and also whether an operation signal for the windshield wiper 16 is being received (step S13). When determination is made in step S13 that the outside air temperature is 1° C or higher and also an operation signal for the windshield wiper 16 is being received, the heater control unit 232 powers up the heater 15 (step S15).

On the other hand, when determination is made in step S13 that the outside air temperature is below 1° C (i.e., below reference temperature), the heater control unit 232 determines whether the continuous reception time of operation signals for the windshield wiper 16 is three seconds or more (i.e., greater than reference time) (step S14). When determination is made in step S14 that the continuous reception time of the operation signals for the windshield wiper 16 is less than three seconds, the heater-on processing ends. Accordingly, powering up of the heater 15 is not started. On the other hand, when determination is made in step S14 that the continuous reception time of operation signals for the windshield wiper 16 is three seconds or more, the heater control unit 232 powers up the heater 15 (step S15).

FIG. 5 is a flowchart showing a flow of heater-off processing for powering down the heater 15. The heater-off processing shown in FIG. 5 is executed by the processor 23 at regular time intervals while the heater 15 is powered up.

When the heater-off processing is started, the heater control unit 232 first determines whether there is snow blockage forward (i.e., on transparent cover 3' and emblem 4) of the millimeter wave radar device 11, in the same way as in step S12 (step S21). When determination is made in step S21 that there is snow blockage, the heater-off process ends, and therefore powering up of the heater 15 continues. On the other hand, when determination is made in step S21 that there is no snow blockage, the heater control unit 232 determines whether the outside air temperature is 1° C or higher and also whether a stop signal to stop the windshield wiper 16 is being received (step S22). When determination is made in step S22 that the outside air temperature is 1° C or higher and also a stop signal to stop the windshield wiper 16 is being received, the heater control unit 232 powers down the heater 15 (step S24).

On the other hand, when determination is made in step S22 that the outside air temperature is not 1° C or higher, the heater control unit 232 determines whether the continuous reception time of stop signals for the windshield wiper 16 is four minutes or more (step S23). When determination is made in step S23 that the continuous reception time of the stop signal for the windshield wiper 16 is less than four minutes, the heater-off processing ends, and accordingly the powering up of the heater 15 continues. On the other hand, when determination is made in step S23 that the continuous reception time of stop signals for the windshield wiper 16 is four minutes or more, the heater control unit 232 powers down the heater 15 (step S24).

Note that in the above embodiment, a ranging sensor including a millimeter wave radar device 11 is used as a sensor. However, a sensor other than a ranging sensor, such as a camera or the like, for example, may be used as the sensor. In this case, the heater 15 is disposed so as to heat an outer face of glass provided forward of the camera, for example.

In the examples shown in FIGS. 4 and 5, the presence or absence of snow blockage is determined in steps S12 and S21. However, whether there is such snow blockage does not have to be determined.

Although a preferred embodiment of the present disclosure has been described above, the present disclosure is not limited to this embodiment, and various modifications and changes can be made within the scope of the claims.

What is claimed is:

1. A heater control device that performs powering up control of a heater provided to heat an outer face of a vehicle, wherein, when an outside air temperature around the vehicle is below a reference temperature that is higher than 0° C, and also an operation signal for a windshield wiper of the vehicle is received continuously for a predetermined reference time that is set in advance, or longer, the heater is powered up.

2. The heater control device according to claim 1, wherein, when the outside air temperature is within a predetermined temperature range including the reference temperature and is the reference temperature or higher, and the operation signal for the windshield wiper of the vehicle is received, the heater is powered up.

3. The heater control device according to claim 2, wherein the temperature range is −5° C to 5° C.

4. The heater control device according to claim 1, wherein the heater heats a sensor provided on the outer face of the vehicle or a transparent cover that covers the sensor provided to the vehicle.

5. The heater control device according to claim 1, wherein, when the outside air temperature is the reference temperature or higher, and also a stop signal for the windshield wiper is received while the heater is powered up, the heater is powered down.
